(19) United States
(12) Patent Application Publication
(10) Pub. No.: US 2023/0047689 A1
(43) Pub. Date: Feb. 16, 2023

(54) APPARATUS AND METHOD FOR AUTONOMOUS VEHICLE NEGOTIATION BASED ON V2V COMMUNICATION

(71) Applicant: Electronics and Telecommunications Research Institute, Daejeon (KR)

(72) Inventors: Shin-Kyung LEE, Daejeon (KR); Do-Wook KANG, Daejeon (KR); Kyoung-Wook MIN, Daejeon (KR); Yoo-Seung SONG, Daejeon (KR)

(73) Assignee: Electronics and Telecommunications Research Institute, Daejeon (KR)

(21) Appl. No.: 17/534,011

(22) Filed: Nov. 23, 2021

(30) Foreign Application Priority Data
Aug. 12, 2021 (KR) 10-2021-0106692

(51) Int. Cl. B60W 30/18; H04W 4/46; H04L 1/16; B60W 60/00

(52) U.S. Cl. CPC B60W 30/18159; H04W 4/46; H04L 1/1685; B60W 60/001; H04L 1/1657; H04L 1/1671; B60W 2556/65; B60W 2554/4041; B60W 2556/50

(57) ABSTRACT

Disclosed herein are an apparatus and a method for autonomous vehicle negotiation based on Vehicle-to-Vehicle (V2V) communication, the method including requesting, by vehicles that enter a driving negotiation section, a driving negotiation token, acquiring, by a vehicle that enters the driving negotiation section first, among the entering vehicles, the driving negotiation token, performing driving negotiation based on whether the driving negotiation token is acquired, and returning, by a vehicle having acquired the driving negotiation token, the driving negotiation token when the vehicle arrives at a destination.

### CROSS REFERENCE TO RELATED APPLICATION

This application claims the benefit of Korean Patent Application No. 10-2021-0106692, filed Aug. 12, 2021, which is hereby incorporated by reference in its entirety into this application.

### BACKGROUND OF THE INVENTION

### 1. Technical Field

The present invention relates generally to technology for determining a route when an autonomous vehicle faces a specific driving situation while driving in a specific driving space. More particularly, the present invention relates to technology for determining a route through negotiation with nearby autonomous vehicles using a driving negotiation token based on Vehicle-to-Vehicle (V2V) communication.

### 2. Description of the Related Art

On general roads, an autonomous vehicle recognizes a lane and generates a local route along which it plans to travel, after which the autonomous vehicle travels to a target point by controlling a steering angle and a speed. However, in uncontrolled intersections (i.e., intersections without traffic signals) or roundabouts in which the number of vehicles is increasing, there is a limitation in the movement of additional vehicles is predicted, and thus independent route generation by an autonomous vehicle itself may further congest the road or may cause the road to reach a deadlock.

Therefore, for a smooth traffic flow in a specific driving negotiation section (an uncontrolled intersection, a roundabout or the like), there is a need to modify/supplement a driving strategy by exchanging information with nearby vehicles based on ultra-high speed V2V communication.

### PRIOR ART DOCUMENTS

### Patent Documents

(Patent Document 1) Korean Patent Application Publication No. 10-2019-0088563 (Title: V2X Communication Device and Method for Transmitting and Receiving V2X Message Thereof)
(Patent Document 2) Korean Patent Application Publication No. 10-2020-0040640 (Title: Lane Change Method in V2V Communication System)

### SUMMARY OF THE INVENTION

Accordingly, the present invention has been made keeping in mind the above problems occurring in the prior art, and an object of the present invention is to provide a method for allowing an autonomous vehicle to smoothly pass through a driving negotiation section, such as an uncontrolled intersection, a roundabout, or a junction, in which the number of vehicles is increasing.

Another object of the present invention is to provide a method for allowing autonomous vehicles to desirably perform negotiation in a driving negotiation section using a driving negotiation token based on V2V communication.

In accordance with an aspect of the present invention to accomplish the above objects, there is provided a method for autonomous vehicle negotiation based on Vehicle-to-Vehicle (V2V) communication, the method including requesting, by vehicles that enter a driving negotiation section, a driving negotiation token, acquiring, by a vehicle that enters the driving negotiation section first, among the entering vehicles, the driving negotiation token, performing driving negotiation based on whether the driving negotiation token is acquired, and returning, by a vehicle having acquired the driving negotiation token, the driving negotiation token when the vehicle arrives at a destination.

Performing the driving negotiation may include requesting, by the vehicle having acquired the driving negotiation token, negotiation to an additional vehicle, receiving a response message from the additional vehicle, and establishing a driving strategy depending on yielding by the additional vehicle when driving.

Each vehicle that enters the driving negotiation section may check position information of nearby vehicles and whether there is any vehicle having acquired the driving negotiation token before entering the driving negotiation section.

Requesting, by the vehicle having acquired the driving negotiation token, negotiation from the additional vehicle may include designating a target vehicle that is to respond to the request, among the additional vehicles.

Receiving the response message from the additional vehicle may include receiving an error message when the additional vehicle is incapable of controlling vehicle functions in response to the request from the vehicle having acquired the driving negotiation token.

The driving negotiation token may be set to be automatically returned when a predetermined time has elapsed even if the vehicle does not arrive at the destination.

The driving negotiation token may be acquired by the special vehicle in advance when the special vehicle enters the driving negotiation section.

The autonomous vehicle negotiation method may further include, when the driving negotiation token acquired by the special vehicle is returned, considering that a driving negotiation token of a vehicle, with which negotiation is not completed before the special vehicle acquires the driving negotiation token in advance, has expired, and acquiring the driving negotiation token.

The driving negotiation section may include a junction, an uncontrolled intersection, and entry/exit points of a roundabout.

Requesting the driving negotiation token may include setting, by the vehicle that enters the driving negotiation section, information indicating possession or non-possession of the driving negotiation token, to a request state, and transmit information about a time at which the vehicle enters the driving negotiation section.

In accordance with another aspect of the present invention to accomplish the above objects, there is provided an apparatus for autonomous vehicle negotiation based on based on Vehicle-to-Vehicle (V2V) communication, the apparatus including an information acquisition unit for acquiring position information of a vehicle, a communication unit for communicating with additional vehicles, and a control unit for controlling driving of the driving vehicle

The control unit may be configured to, when the vehicle enters a driving negotiation section, request a driving negotiation token, acquire the driving negotiation token based on a time at which the vehicle enters the driving negotiation section, perform driving negotiation based on whether the driving negotiation token is acquired, and return the driving negotiation token when the vehicle arrives at a destination.

The communication unit may be configured to request negotiation to an additional vehicle when the driving negotiation token is acquired, and to receive a response message from the additional vehicle.

The control unit may be configured to establish a driving strategy based on yielding by the additional vehicle when driving.

The communication unit may be configured to check position information of nearby vehicles and whether there is any vehicle having acquired the driving negotiation token before entering the driving negotiation section.

The control unit may be configured to designate a target that is to respond to the negotiation request made by the communication unit among additional vehicles.

The control unit may be configured to receive an error message when the additional vehicle is incapable of controlling vehicle functions in response to the request from the vehicle having acquired the driving negotiation token.

The driving negotiation token may be automatically returned when a predetermined time has elapsed even if the vehicle does not arrive at the destination.

The control unit may be configured to, when a special vehicle enters the driving negotiation section, control the special vehicle such that the special vehicle acquires the driving negotiation token in advance and preferentially passes through the driving negotiation section.

The control unit may be configured to, when the driving negotiation token acquired by the special vehicle is returned, consider that a driving negotiation token of a vehicle, with which negotiation is not completed before the special vehicle, has expired, and again acquire the driving negotiation token.

The driving negotiation section may include a junction, an uncontrolled intersection, and entry/exit points of a roundabout.

The communication unit may be configured to, when the vehicle enters the driving negotiation section, set information indicating possession or non-possession of the driving negotiation token to a request state, and transmit information about a time at which the vehicle enters the driving negotiation section.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram of negotiation in a driving negotiation section using Vehicle-to-Everything (V2X) communication between autonomous vehicles;

FIG. 2 is a diagram illustrating an example of a method for determining a driving negotiation section in a roundabout;

FIG. 3 is a flowchart of a method for autonomous vehicle negotiation based on V2V communication according to an embodiment of the present invention;

FIG. 4 is a diagram conceptually illustrating a driving negotiation section in a method for autonomous vehicle negotiation based on V2V communication according to an embodiment of the present invention;

FIG. 5 is a flowchart illustrating a method for acquiring and returning a driving negotiation token;

FIG. 6 is a flowchart illustrating a driving negotiation procedure performed by an autonomous vehicle in a driving negotiation section;

FIG. 7 is a block diagram illustrating an apparatus for autonomous vehicle negotiation based on V2V communication according to an embodiment of the present invention; and

FIG. 8 is a diagram illustrating the configuration of a computer system according to an embodiment.

### DESCRIPTION OF THE PREFERRED EMBODIMENTS

Advantages and features of the present invention and methods for achieving the same will be clarified with reference to embodiments described later in detail together with the accompanying drawings. However, the present invention is capable of being implemented in various forms, and is not limited to the embodiments described later, and these embodiments are provided so that this invention will be thorough and complete and will fully convey the scope of the present invention to those skilled in the art. The present invention should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present invention.

The terms used in the present specification are merely used to describe embodiments, and are not intended to limit the present invention. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present invention pertains. Further, terms defined in generally used dictionaries are not to be interpreted as having ideal or excessively formal meanings unless they are definitely defined in the present specification.

Hereinafter, embodiments of the present invention will be described in detail with reference to the accompanying drawings. In the following description of the present invention, the same reference numerals are used to designate the same or similar elements throughout the drawings and repeated descriptions of the same components will be omitted.

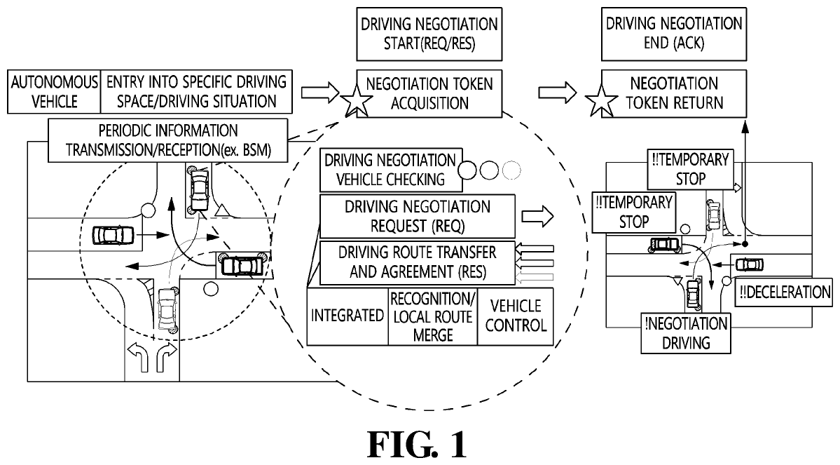

FIG. 1 is a conceptual diagram of negotiation in a driving negotiation section using Vehicle-to-Everything (V2X) communication between autonomous vehicles.

Referring to FIG. 1, it can be seen that a V2X communication-based driving negotiation method using road infrastructure or the like is illustrated.

An autonomous vehicle generally travels along the center (or the central line) of each roadway based on lanes, and is configured such that, when it is desired to attempt to perform a roadway change (e.g., cut-in or cut-out) or a lane change, the corresponding lane is changed by adjusting a steering angle (orientation of the vehicle), a vehicle speed, or the like after it is determined that a dangerous factor is not present in a surrounding environment through sensors (e.g., a camera, LiDAR, radar, or the like) mounted on a subject vehicle.

Through extension of this structure, broadcast information including the positions of additional vehicles is referred to by utilizing V2X communication to avoid a vehicle collision on a backside road or a narrow road, but the autonomous vehicle still independently generates a driving route or corrects/supplements the driving route thereof in response to a request received from an omniscient infrastructure system.

A method for autonomous vehicle negotiation based on Vehicle-to-Vehicle (V2V) communication according to an embodiment of the present invention is a method for establishing a driving strategy (route supplementation and driving) through negotiation between an autonomous vehicle and a nearby vehicle (an autonomous vehicle or a connected car) without the assistance of infrastructure.

Here, for prompt negotiation, a section in which the movement of the autonomous vehicle can greatly influence the flow of additional vehicles on the road is designated as a driving negotiation section (e.g., a junction, the entire uncontrolled intersection, and entry/exist points of a roundabout) that separately requires negotiation.

In the driving negotiation section, the occurrence of a time delay in autonomous vehicles caused by a preliminary procedure before negotiation may be minimized by exploiting a driving negotiation token to be used to lead negotiation between vehicles. Any of autonomous vehicles, entering the designated negotiation section, acquires the driving negotiation token first and becomes the subject of negotiation, and is then capable of determining negotiation objects (target vehicles).

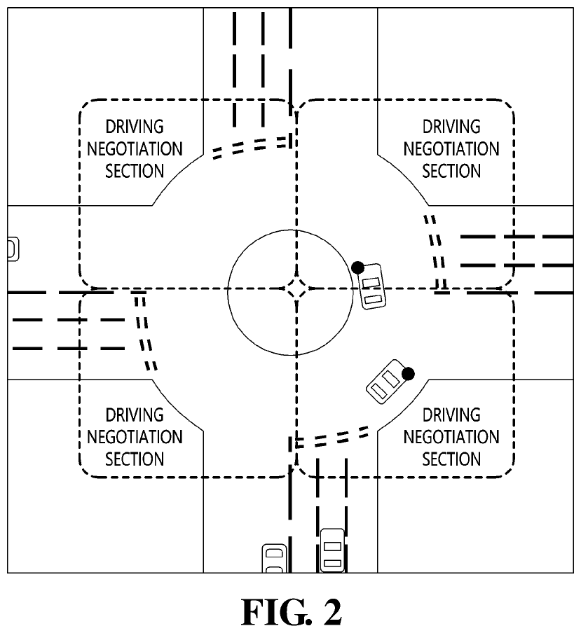

FIG. 2 is a diagram illustrating an example of a method for setting a driving negotiation section in a roundabout.

Referring to FIG. 2, it can be seen that entry/exit points of the roundabout are set as respective driving negotiation sections, and thus four driving negotiation sections are set.

However, the scope of the present invention is not limited thereto, and the number of driving negotiation sections in the roundabout may be set to various values, such as 1, 2 and 4.

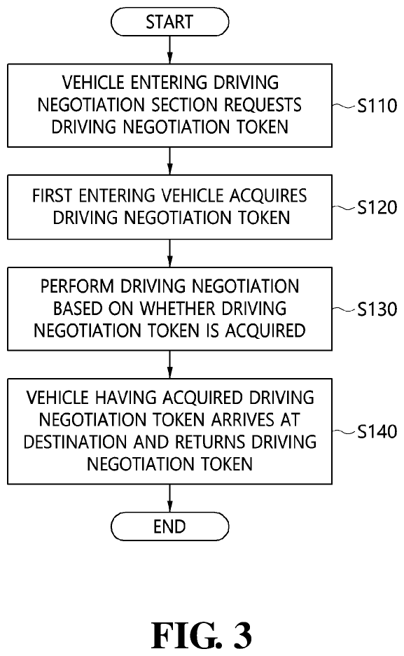

FIG. 3 is a flowchart illustrating a method for autonomous vehicle negotiation based on V2V communication according to an embodiment of the present invention.

Referring to FIG. 3, in the negotiation method performed by an apparatus for autonomous vehicle negotiation based on V2V communication, when each autonomous vehicle enters a driving negotiation section, the autonomous vehicle requests a driving negotiation token at step S110.

Next, the autonomous vehicle that enters the driving negotiation section first acquires the driving negotiation token at step S120.

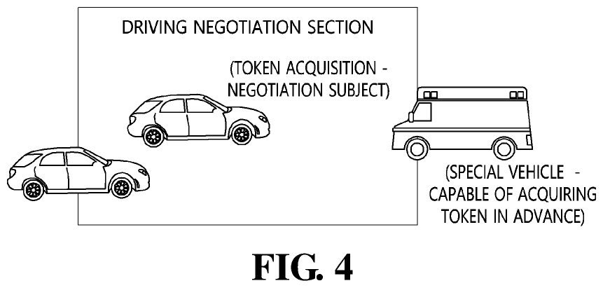

FIG. 4 is a diagram conceptually illustrating a driving negotiation section in a method for autonomous vehicle negotiation based on V2V communication according to an embodiment of the present invention.

A method for acquiring a driving negotiation token is performed such that the vehicle that has entered first a section indicated by a driving negotiation section (positions of x and y coordinates based on a two-dimensional (2D) box) in a High-Definition (HD) map or a Local Dynamic Map (LDM) acquires the driving negotiation token.

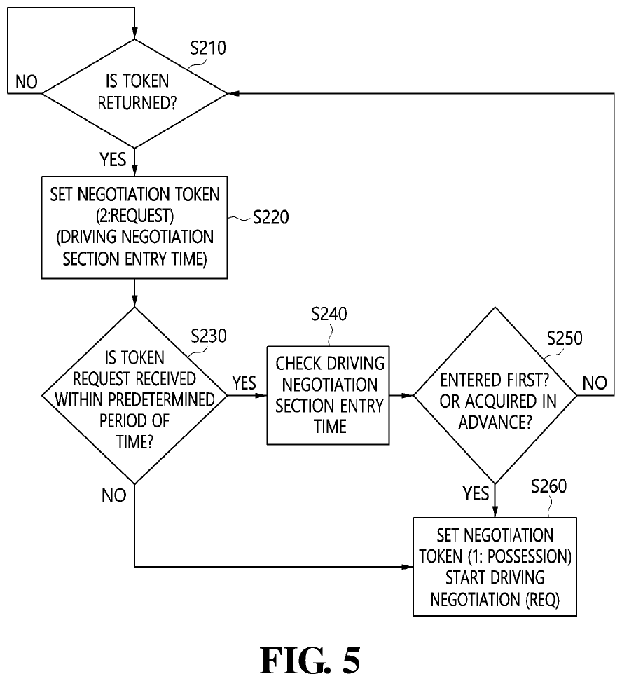

FIG. 5 is a flowchart illustrating a method for acquiring and returning a driving negotiation token.

Referring to FIG. 5, when the vehicle having previously acquired the driving negotiation token arrives at a destination, the token is returned at step S210.

At this time, an autonomous vehicle that currently enters the driving negotiation section may set information, indicating whether the autonomous vehicle possesses a driving negotiation token, that is, possession or non-possession of the driving negotiation token, to ‘2’ (a request state) in information required to periodically broadcast position information using V2V communication, and broadcasts the start time of entry at step S220.

Each vehicle listening to the broadcast does not send a separate response unless the corresponding vehicle enters the driving negotiation section first and requires driving negotiation, after which the vehicle does not attempt negotiation until the driving negotiation token is returned (or expires after a predetermined time has elapsed) at step S230.

When a token request is not received within the predetermined time(period), the autonomous vehicle sets the information indicating possession or non-possession of the driving negotiation token to ‘1’ (a possession state), and becomes the subject of driving negotiation to perform negotiation at step S260.

When a token request is received within the predetermined time, entry times at which respective vehicles enter the driving negotiation section are checked at step S240. When the corresponding autonomous vehicle has entered the driving negotiation section first, or has acquired the driving negotiation token in advance, driving negotiation starts at steps S250 and S260.

Here, a special vehicle, such as a police car or an ambulance, is allowed to use a separate token possession number (e.g., 99: emergency), and is then capable of acquiring the token in advance and preferentially passing through the driving negotiation section even if the autonomous vehicle having entered the driving negotiation section first is performing negotiation.

In this case, even if the driving negotiation token of the special vehicle is returned, the driving negotiation token of the vehicle with which negotiation is not yet completed is regarded as expired, and a procedure for acquiring the driving negotiation token is again undertaken.

Next, the negotiation method performed by the apparatus for autonomous vehicle negotiation based on V2V communication performs driving negotiation with additional vehicles based on whether the driving negotiation token is acquired at step S130.

Step S130 of performing driving negotiation with the additional vehicles may include the step of allowing the vehicle having acquired the driving negotiation token to request negotiation from the additional vehicle, the step of receiving a response message from the additional vehicle, and the step of establishing a driving strategy depending on yielding by the additional vehicle when driving.

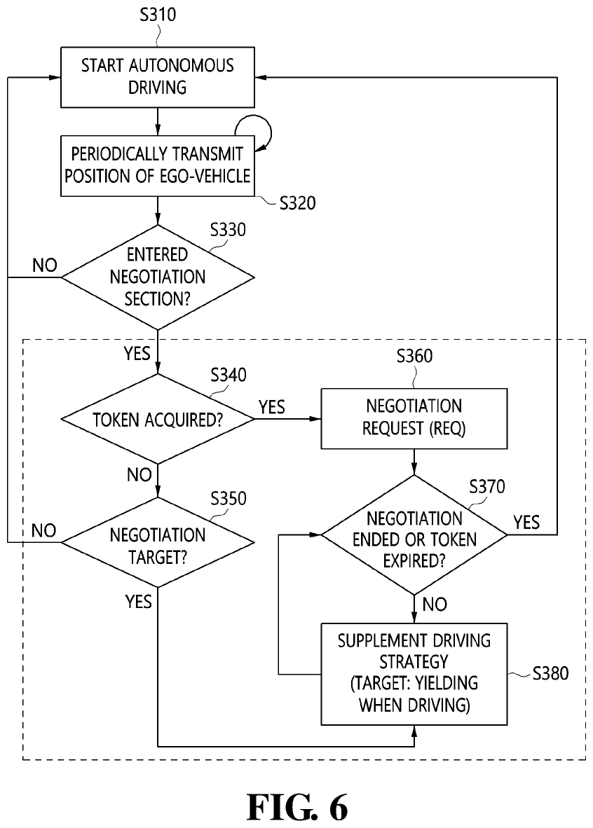

FIG. 6 is a flowchart illustrating a driving negotiation procedure performed in a driving negotiation section by an autonomous vehicle.

Referring to FIG. 6, an autonomous vehicle that starts autonomous driving periodically transmits position information thereof, as the position of a subject vehicle (also referred to as an ego-vehicle), together with a Media Access Control (MAC) address (or IP address) of a communication device, such as a unique ID, using V2V communication at steps S310 and S320.

The following Table 1 shows information of messages required for negotiation in the driving negotiation section by the autonomous vehicle.

TABLE 1
Basic Safety Message (BSM)/basic information
MAC address of communication device (unique ID of communication
device, and IP address is also available)
Position of subject vehicle
Information required for negotiation between autonomous vehicles
possession or non-possession of negotiation token (0: non-possession,
1: possession, 2: request, 99: emergency)
list of unique numbers of negotiation participants (ex. 2, aa:bb:cc:dd:ee,
11:22:33:44:55:66)
negotiation state (REQ: negotiation request/ACK: end | RES: response/
ERR: non-negotiable)
negotiation start/end or expiration time
negotiation section entry time

Before the autonomous vehicle (subject vehicle or ego-vehicle) enters the driving negotiation section, position information of nearby vehicles is checked, and it is also checked whether there is any vehicle requesting or possessing a driving negotiation token while the subject vehicle enters the driving negotiation section. Thereafter, when the autonomous vehicle enters the driving negotiation section at step S330, it acquires the driving negotiation token, and sends a driving negotiation request message REQ at steps S340 and S360.

Here, among the nearby vehicles, the targets that are to make a negotiation response RES are designated (the number of negotiation target vehicles and a list of MAC addresses of the communication devices, e.g., 2, aa:bb:cc:dd:ee, 11:22:33:44:55:66).

The target vehicles (target vehicles) participating in negotiation may send negotiation response messages RES in response to the driving negotiation request message, and may reduce the speeds thereof while maintaining sufficient distance from the vehicle ahead so that the negotiation subject (ego-vehicle) can drive in the driving negotiation section at step S380.

At this time, when a certain participant vehicle (target vehicle) is inevitably incapable of controlling vehicle functions thereof in response to the request from the negotiation subject (ego-vehicle) due to an accident or the like, the certain participant vehicle allows the negotiation subject (ego-vehicle) to recognize that the negotiation subject (ego-vehicle) cannot negotiate with the certain participant vehicle by returning an error message ERR. The negotiation subject (ego-vehicle) may check the responses of the participant vehicles (target-vehicles), may establish a real-time driving strategy (local route) depending on yielding by the participant vehicles (target-vehicles) when driving, and may then autonomously drive in the driving negotiation section.

When the negotiation subject (ego-vehicle) arrives at the destination, a negotiation end message ACK is broadcasted (i.e., information indicating possession or non-possession of the driving negotiation token is changed to a ‘non-possession’ state), and the driving negotiation token is automatically returned when the validity of the driving negotiation token has expired even if the negotiation subject has not yet arrived at the destination at step S370. When the driving negotiation token is returned, vehicles remaining in the specific driving space (driving negotiation section) may again progress negotiation.

When the vehicle having acquired the driving negotiation token arrives at the destination by means of the above-described procedure, the vehicle returns the driving negotiation token at step S140.

Here, when a preset time period has elapsed even if the autonomous vehicle does not arrive at the destination, the driving negotiation token may be designated to be automatically returned.

Further, even if an autonomous vehicle has entered the driving negotiation section, when the autonomous vehicle does not correspond to a driving negotiation target or is independently determined not to require separate driving negotiation, the autonomous vehicle drives in line with independent driving policies identical to existing policies.

However, a participant vehicle (target vehicle) from which a vehicle having acquired a driving negotiation token requests driving negotiation and which recognizes that the corresponding participant vehicle is a negotiation target must preferentially perform yielding control when driving (such as by maintaining sufficient distance from a vehicle ahead and reducing a speed) with higher priority than that of driving determination of the participant vehicle itself so that a request from the negotiation subject (ego-vehicle) can be promptly processed.

Further, when the negotiation subject (ego-vehicle) additionally requests recognized information while negotiation is being performed (negotiation state REQ2: recognized object information request), participant vehicles (target vehicles) send the results of detecting objects located ahead as responses (negotiation state RES2: pieces of recognized object information that are detected).

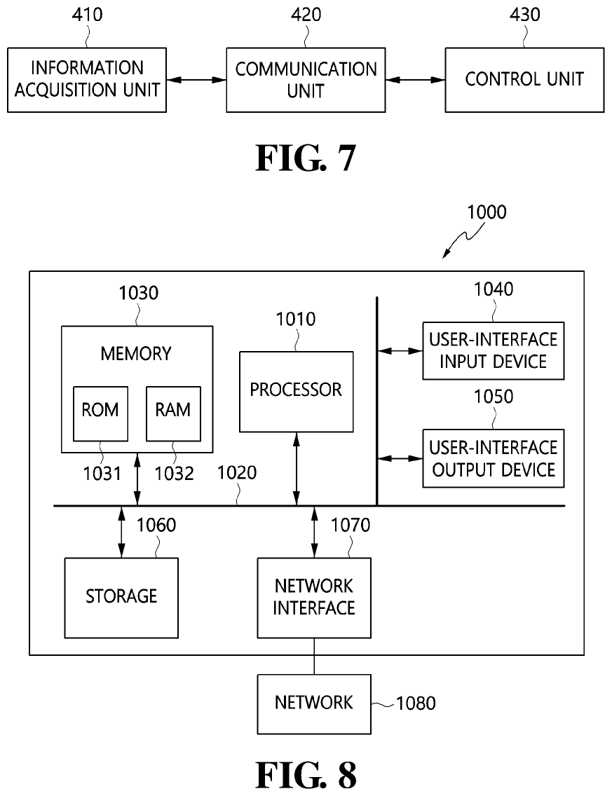

FIG. 7 is a block diagram illustrating an apparatus for autonomous vehicle negotiation based on V2V according to an embodiment of the present invention.

Referring to FIG. 7, the apparatus for autonomous vehicle negotiation based on V2V according to the embodiment of the present invention includes an information acquisition unit 410 for acquiring information including the position information of a vehicle, a communication unit 420 for communicating with additional vehicles, and a control unit 430 for controlling the driving of an autonomous vehicle.

Here, the control unit 430 is configured to, when the autonomous vehicle enters a driving negotiation section, request a driving negotiation token, acquire the driving negotiation token based on the time (entry time) at which the autonomous vehicle enters the driving negotiation section, perform driving negotiation based on whether the driving negotiation token is acquired, and return the driving negotiation token when the autonomous vehicle arrives at a destination.

The communication unit 420 may be configured to, when the driving negotiation token is acquired, request negotiation from additional vehicles, and receive response messages from the additional vehicles.

Here, the control unit 430 may establish a driving strategy depending on yielding by the additional vehicles when driving.

Here, the communication unit 420 may check the position information of nearby vehicles before entering the driving negotiation section and determine whether there is any vehicle that has acquired the driving negotiation token.

The control unit 430 may designate the target that is to respond to the negotiation request made by the communication unit, among the additional vehicles.

Here, when a certain vehicle cannot control vehicle functions thereof in response to the request from the autonomous vehicle that has acquired the driving negotiation token, the communication unit 420 may receive an error message.

The driving negotiation token may be automatically returned even if the autonomous vehicle does not arrive at a destination when a preset time has elapsed.

The control unit 430 is configured to, when a special vehicle enters the driving negotiation section, control the special vehicle to acquire the driving negotiation token in advance and preferentially pass through the driving negotiation section.

When the driving negotiation token of the special vehicle is returned, the control unit 430 considers that the driving negotiation token, for which negotiation is not completed before the special vehicle, has expired, and may acquire the driving negotiation token again.

Here, the driving negotiation section may include a junction, an uncontrolled intersection, and entry/exit points of a roundabout.

Here, when the autonomous vehicle enters the driving negotiation section, the communication unit 420 may set information indicating possession or non-possession of the driving negotiation token to a “request” state, and may transmit information about the time (entry start time) at which the autonomous vehicle enters the driving negotiation section.

FIG. 8 is a diagram illustrating the configuration of a computer system according to an embodiment.

An apparatus for autonomous vehicle negotiation based on V2V communication according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium, and an information delivery medium. For example, the memory 1030 may include Read-Only Memory (ROM) 1031 or Random Access Memory (RAM) 1032.

According to the present invention, when an autonomous vehicle enters a junction, an uncontrolled intersection, or entry/exit points of a roundabout, and takes an action influencing the flow of nearby vehicles, such as cutting in or changing a lane, a method of exploiting a negotiation token to be used to lead negotiation between vehicles based on V2V communication, rather than a method based on only independent determination/control, may be provided, and a driving route may be corrected/supplemented based on the method so as to smoothly form a traffic flow.

By means of this, an autonomous vehicle having a negotiation token may clarify intention to drive, and may then control a traffic flow with the assistance of nearby vehicles, thus breaking the deadlock.

Specific executions described in the present invention are embodiments, and the scope of the present invention is not limited to specific methods. For simplicity of the specification, descriptions of conventional electronic components, control systems, software, and other functional aspects of the systems may be omitted. As examples of connections of lines or connecting elements between the components illustrated in the drawings, functional connections and/or circuit connections are exemplified, and in actual devices, those connections may be replaced with other connections, or may be represented by additional functional connections, physical connections or circuit connections. Furthermore, unless definitely defined using the term “essential”, “significantly” or the like, the corresponding component may not be an essential component required in order to apply the present invention.

In accordance with the present invention, an autonomous vehicle may smoothly pass through a driving negotiation section, such as an uncontrolled intersection, a roundabout, or a junction, in which the number of vehicles is increasing.

Further, the present invention may provide a method for allowing autonomous vehicles to desirably perform negotiation in a driving negotiation section using a driving negotiation token based on V2V communication.

Therefore, the spirit of the present invention should not be limitedly defined by the above-described embodiments, and it is appreciated that all ranges of the accompanying claims and equivalents thereof belong to the scope of the spirit of the present invention.

What is claimed is:

1. A method for autonomous vehicle negotiation based on Vehicle-to-Vehicle (V2V) communication, the method comprising:
requesting, by vehicles that enter a driving negotiation section, a driving negotiation token;
acquiring, by a vehicle that enters the driving negotiation section first, among the entering vehicles, the driving negotiation token;
performing driving negotiation based on whether the driving negotiation token is acquired; and
returning, by a vehicle having acquired the driving negotiation token, the driving negotiation token when the vehicle arrives at a destination.

2. The autonomous vehicle negotiation method of claim 1, wherein performing the driving negotiation comprises:
requesting, by the vehicle having acquired the driving negotiation token, negotiation to an additional vehicle;
receiving a response message from the additional vehicle; and
establishing a driving strategy depending on yielding by the additional vehicle.

3. The autonomous vehicle negotiation method of claim 2, wherein each vehicle that enters the driving negotiation section checks position information of nearby vehicles and whether there is any vehicle having acquired the driving negotiation token before entering the driving negotiation section.

4. The autonomous vehicle negotiation method of claim 3, wherein requesting, by the vehicle having acquired the driving negotiation token, negotiation from the additional vehicle comprises:
designating a target vehicle that is to respond to the request, among the additional vehicles.

5. The autonomous vehicle negotiation method of claim 4, wherein receiving the response message from the additional vehicle comprises:
receiving an error message when the additional vehicle is incapable of controlling vehicle functions in response to the request from the vehicle having acquired the driving negotiation token.

6. The autonomous vehicle negotiation method of claim 5, wherein the driving negotiation token is automatically returned when a predetermined time period has elapsed even if the vehicle does not arrive at the destination.

7. The autonomous vehicle negotiation method of claim 1, wherein the driving negotiation token is acquired by the special vehicle in advance when the special vehicle enters the driving negotiation section.

8. The autonomous vehicle negotiation method of claim 7, further comprising:
when the driving negotiation token acquired by the special vehicle is returned, considering that a driving negotiation token of a vehicle, with which negotiation is not completed before the special vehicle acquires the driving negotiation token in advance, has expired, and acquiring the driving negotiation token.

9. The autonomous vehicle negotiation method of claim 1, wherein the driving negotiation section includes a junction, an uncontrolled intersection, and entry/exit points of a roundabout.

10. The autonomous vehicle negotiation method of claim 1, wherein requesting the driving negotiation token comprises:
setting, by the vehicle that enters the driving negotiation section, information indicating possession or non-possession of the driving negotiation token, to a request state, and transmit information about a time at which the vehicle enters the driving negotiation section.

11. An apparatus for autonomous vehicle negotiation based on based on Vehicle-to-Vehicle (V2V) communication, the apparatus comprising:
an information acquisition unit for acquiring position information of a vehicle;
a communication unit for communicating with additional vehicles; and
a control unit for controlling driving of the driving vehicle,
wherein the control unit is configured to, when the vehicle enters a driving negotiation section, request a driving negotiation token, acquire the driving negotiation token based on a time at which the vehicle enters the driving negotiation section, perform driving negotiation based on whether the driving negotiation token is acquired, and return the driving negotiation token when the vehicle arrives at a destination.

12. The autonomous vehicle negotiation apparatus of claim 11, wherein:
the communication unit is configured to request negotiation to an additional vehicle when the driving negotiation token is acquired, and to receive a response message from the additional vehicle, and
the control unit is configured to establish a driving strategy based on yielding by the additional vehicle.

13. The autonomous vehicle negotiation apparatus of claim 12, wherein the communication unit is configured to check position information of nearby vehicles and whether there is any vehicle having acquired the driving negotiation token before entering the driving negotiation section.

14. The autonomous vehicle negotiation apparatus of claim 13, wherein the control unit is configured to designate a target that is to respond to the negotiation request made by the communication unit among additional vehicles.

15. The autonomous vehicle negotiation apparatus of claim 14, wherein the control unit is configured to receive an error message when the additional vehicle is incapable of controlling vehicle functions in response to the request from the vehicle having acquired the driving negotiation token.

16. The autonomous vehicle negotiation apparatus of claim 15, wherein the driving negotiation token is automatically returned when a predetermined time period has elapsed even if the vehicle does not arrive at the destination.

17. The autonomous vehicle negotiation apparatus of claim 11, wherein the control unit is configured to, when a special vehicle enters the driving negotiation section, control the special vehicle such that the special vehicle acquires the driving negotiation token in advance and preferentially passes through the driving negotiation section.

18. The autonomous vehicle negotiation apparatus of claim 17, wherein the control unit is configured to, when the driving negotiation token acquired by the special vehicle is returned, consider that a driving negotiation token of a vehicle, with which negotiation is not completed before the special vehicle, has expired, and again acquire the driving negotiation token.

19. The autonomous vehicle negotiation apparatus of claim 11, wherein the driving negotiation section includes a junction, an uncontrolled intersection, and entry/exit points of a roundabout.

20. The autonomous vehicle negotiation apparatus of claim 11, wherein the communication unit is configured to, when the vehicle enters the driving negotiation section, set information indicating possession or non-possession of the driving negotiation token to a request state, and transmit information about a time at which the vehicle enters the driving negotiation section.
